(19) United States
(12) Patent Application Publication
(10) Pub. No.: US 2010/0005810 A1
(43) Pub. Date: Jan. 14, 2010

(54) POWER TRANSMISSION AMONG SHAFTS IN A TURBINE ENGINE

(76) Inventors: Rob Jarrell, Brownsburg, IN (US); Andrew D. Copeland, Greenwood, IN (US)

Correspondence Address: MacMillan, Sobanski & Todd, LLC, One Maritime Plaza, Fifth Floor, 720 Water Street, Toledo, OH, 43604, US

(21) Appl. No.: 12/171,532

(22) Filed: Jul. 11, 2008

(51) Int. Cl. F02C 3/10

(52) U.S. Cl. 60/792; 60/224

(57) ABSTRACT

A method of transmitting power among a plurality of shafts in a turbine engine is disclosed herein as well as a turbine engine for practicing the method. The turbine engine includes a compressor section having a low pressure portion and a high pressure portion. The turbine engine also includes a turbine section spaced from the compressor section along a centerline axis. The turbine section includes a low pressure portion and a high pressure portion. The turbine engine also includes a low pressure shaft extending between the low pressure portion of the compressor section and the low pressure portion of the turbine section. The turbine engine also includes a high pressure shaft extending between the high pressure portion of the compressor section and the high pressure portion of the turbine section. The turbine engine also includes a tower shaft operably engaged with both of the low pressure shaft and the high pressure shaft. The tower shaft can impart initial rotation to the high pressure shaft and the low pressure shaft can transmit power through the tower shaft after initial rotation has been imparted to the high pressure shaft.

### BACKGROUND OF THE INVENTION

1. Field of the Invention

The invention relates to turbine engines generally and to interaction among various shafts within a turbine engine more specifically.

2. Description of Related Prior Art

U.S. Pat. No. 7,055,330 discloses an apparatus for driving an accessory gearbox in a gas turbine engine. Referring to an applying the reference numbers of the '330 patent, the apparatus includes a low pressure drive shaft (14) extending between and connected to a low pressure compressor (16) and a low pressure turbine (22). A tower shaft (32) is connected by a first gear arrangement (34) to the low pressure drive shaft (14). A lay shaft (38) is connected by a second gear arrangement (36) to the tower shaft (32). The lay shaft (38) is also connected to an accessory gearbox (24). The first gear arrangement (34) includes a first gear (44), a second gear (46), a third gear (50), a fourth gear (52), and an intermediate shaft (48). The first gear (44) is attached to the low pressure drive shaft (14). The second gear (46) and the third gear (50) are attached to the intermediate shaft (48). The fourth gear (52) is attached to the tower shaft (32). The first gear (14) is engaged with the second gear (46) and the third gear (50) is engaged with the fourth gear (52).

### SUMMARY OF THE INVENTION

In summary, the invention is a method of transmitting power among a plurality of shafts in a turbine engine and also a turbine engine for practicing the method. The turbine engine includes a compressor section having a low pressure portion and a high pressure portion. The turbine engine also includes a turbine section spaced from the compressor section along a centerline axis. The turbine section includes a low pressure portion and a high pressure portion. The turbine engine also includes a low pressure shaft extending between the low pressure portion of the compressor section and the low pressure portion of the turbine section. The turbine engine also includes a high pressure shaft extending between the high pressure portion of the compressor section and the high pressure portion of the turbine section. The turbine engine also includes a tower shaft operably engaged with both of the low pressure shaft and the high pressure shaft. The tower shaft can impart initial rotation to the high pressure shaft and the low pressure shaft can transmit power through the tower shaft after initial rotation has been imparted to the high pressure shaft.

### BRIEF DESCRIPTION OF THE DRAWINGS

Advantages of the present invention will be readily appreciated as the same becomes better understood by reference to the following detailed description when considered in connection with the accompanying drawings wherein:

FIG. 1 is a schematic representation of a turbine engine incorporating a first exemplary embodiment of the invention; and

FIG. 2 is a detailed cross-section showing the structural interaction among various shafts within the turbine engine in the first exemplary embodiment of the invention.

### DETAILED DESCRIPTION OF THE EXEMPLARY EMBODIMENT

It can be desirable to start the rotation of a high pressure shaft in a turbine engine with a tower shaft. Rotation of the high pressure shaft starts the operation of the turbine engine. However, after the turbine engine has been started, the tower shaft draws power off the high pressure shaft and can compromise the responsiveness of the turbine engine. This will be described in greater detail below. On the other hand, arranging the tower shaft to draw power off a low pressure shaft of the turbine engine can enhance engine responsiveness and also possibly enhance efficiency. However, such an arrangement would require the turbine engine to include some additional structure to rotate the high pressure shaft in order to start the turbine engine. The present invention, as demonstrated by the exemplary embodiment disclosed below, can take advantage of the respective benefits associated with engaging the tower shaft with the high pressure shaft and with engaging the tower shaft with the low pressure shaft.

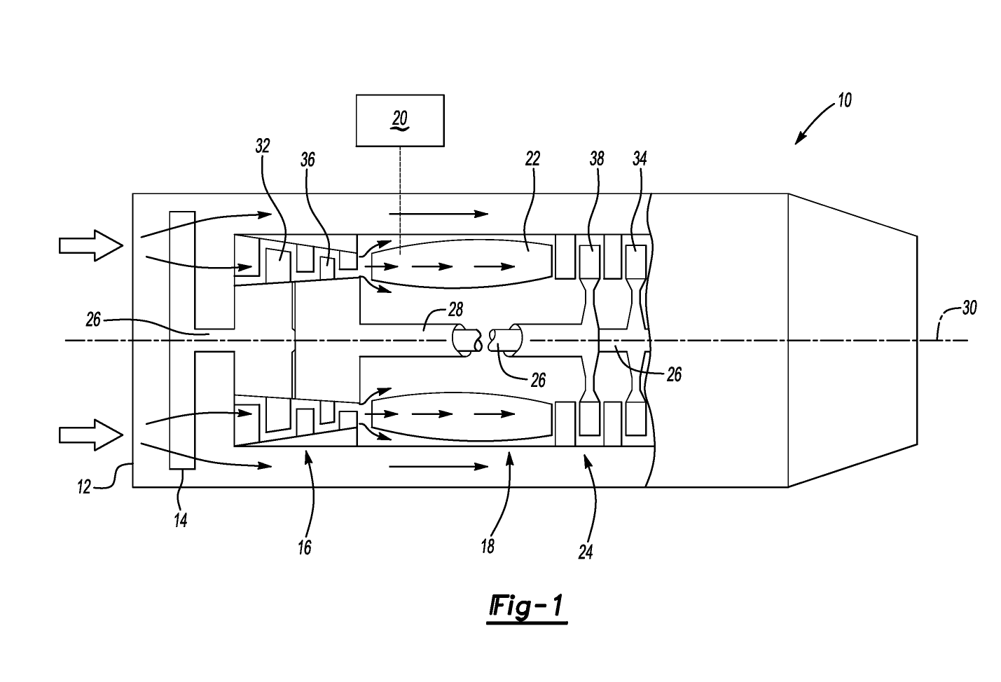

FIG. 1 schematically shows a turbine engine 10. The various unnumbered arrows represent the flow of fluid through the turbine engine 10. The turbine engine 10 can produce power for several different kinds of applications, including vehicle propulsion and power generation, among others. The exemplary embodiment of the invention disclosed herein, as well as the broader invention, can be practiced in any configuration of turbine engine and for any application.

The exemplary turbine engine 10 can include an inlet 12 with a fan 14 to receive fluid such as air. Alternative embodiments of the invention may not include a fan. The turbine engine 10 can also include a compressor section 16 to receive the fluid from the inlet 12 and compress the fluid. The turbine engine 10 can also include a combustor section 18 to receive the compressed fluid from the compressor section 16. The compressed fluid can be mixed with fuel from a fuel system 20 and ignited in a combustion chamber 22 defined by the combustor section 18. The turbine engine 10 can also include a turbine section 24 to receive the combustion gases from the combustor section 18. The energy associated with the combustion gases can be converted into kinetic energy (motion) in the turbine section 24.

In FIG. 1, shafts 26, 28 are shown disposed for rotation about a centerline axis 30 of the turbine engine 10. Alternative embodiments of the invention can include any number of shafts. The shafts 26, 28 can be journaled together for relative rotation. The shaft 26 can be a low pressure shaft supporting compressor blades 32 of a low pressure portion of the compressor section 16. The shaft 26 can also support low pressure turbine blades 34 of a low pressure portion of the turbine section 24.

The shaft 28 encircles the shaft 26. Bearings can be disposed between the shafts 26, 28. The shaft 28 can be a high pressure shaft supporting compressor blades 36 of a high pressure portion of the compressor section 16. The shaft 28 can also support high pressure turbine blades 38 of a high pressure portion of the turbine section 24.

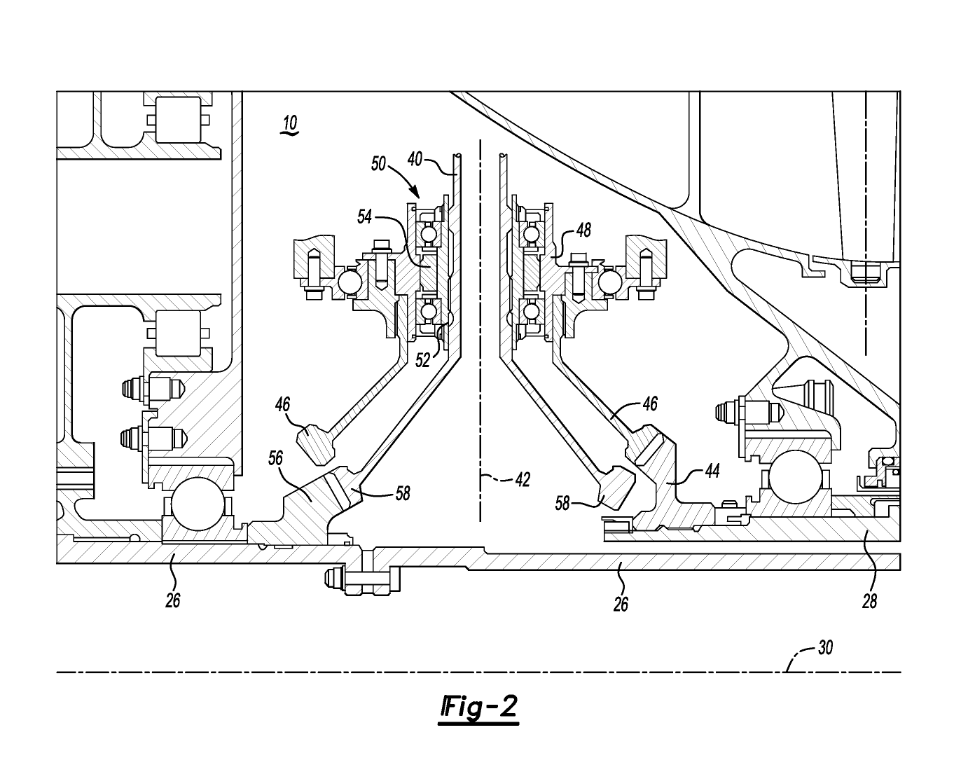

FIG. 2 is a detailed cross-section of the turbine engine 10 showing the structural interaction among various shafts within a turbine engine 10. The low pressure shaft 26 and the high pressure shaft 28 are shown disposed for rotation about the centerline axis 30. FIG. 2 also shows a tower shaft 40 operably engaged with both of the low pressure shaft 26 and the high pressure shaft 28. The tower shaft 40 can rotate about an axis 42; the axis 42 can be perpendicular or other to the centerline axis 30.

The exemplary tower shaft 40 can be utilized to start the operation of the turbine engine 10 and can also be utilized to transmit power from the turbine engine 10 during operation. As will be discussed in greater detail below, during start-up of the turbine engine 10, power can be applied to the tower shaft 40 from a source (not shown) and the tower shaft 40 can drive the high pressure shaft 28 into rotation via the starter shaft 48. After the turbine engine 10 is operating, the source of power initially applied to the tower shaft 40 can cease. Then, power can be transmitted in reverse, from the turbine engine 10, through the tower shaft 40 and to accessories of the turbine engine 10. The power is transmitted through the tower shaft 40 from the low pressure shaft 26. The tower shaft 40 can transmit power to operate generators, pumps, air/lubricant separators, or any other accessory to the turbine engine 10. An end of the tower shaft 40 that is configured to engage accessories or gearing for accessories is not shown in FIG. 2 but can be configured with gears or any structure desired to transmit power.

It is typical in the art that a tower shaft is continuously engaged with a high pressure shaft. As result, accessories are powered by the high pressure shaft through the tower shaft while the turbine engine is operating. The draw of power off the high pressure shaft is a factor that limits the responsiveness of the turbine engine. For example, when it is desired to increase the power production of the turbine engine (to increase vehicle speed or to increase power generation), the rate at which power production can increase will be compromised if accessories are powered by the high pressure shaft.

The reason for this is that the turbine engine will be designed and controlled to follow an acceleration schedule. The acceleration schedule controls the rate at which a turbine engine will accelerate and is developed based on several factors. One of the factors contributing to the acceleration schedule is the draw of power off the high pressure shaft. If, for example, a relatively greater amount of power is being drawn off the high pressure shaft, the turbine engine will accelerate at a relatively slower rate.

The acceleration schedule is developed and applied to prevent rotating stall and/or surge, two operating conditions that can result when a turbine engine is pushed too aggressively. In a rotating stall, the compressor section of the turbine engine can experience dramatic increases in load. During compressor surge, the combustor section can experience variable and rapid increases in temperature, causing the compressor to also experience rapid increases in temperature.

In the exemplary embodiment of the invention, power for accessories can be drawn from the low pressure shaft 26, allowing the acceleration schedule of the turbine engine 10 to be more robust and allowing the turbine engine to be more responsive. In other words, since power is not being drawn off the high pressure shaft 28, the high pressure shaft 28 can be accelerated more aggressively with less risk of rotating stall or surging. The acceleration schedule of the turbine engine 10 need not necessarily be compromised by the draw of power off the high pressure shaft 28 through the tower shaft 40.

It is also noted that for the exemplary turbine engine 10, the draw of accessory power off the low pressure shaft 26 can increase the efficiency of the turbine engine 10. It has been found in some applications that less fuel is burned to draw a desired amount of power for accessories when power is drawn from the low pressure shaft 26 rather than the high pressure shaft 28.

As set forth above, the tower shaft 40 can be operably engaged with the high pressure shaft 28 to start the operation of the turbine engine 10. In the exemplary embodiment of the invention, a gear 44 can be fixed to the high pressure shaft 28. A gear 46 can be positioned to mesh with the gear 44. The gear 46 can be fixed to a starter shaft 48. A clutch 50 can be operably positioned between the tower shaft 40 the starter shaft 48. The exemplary clutch 50 can be a sprag clutch with an outer race defined by the starter shaft 48, an inner race 52 rotationally fixed to the tower shaft 40, and a plurality of sprags 54 positioned between the starter shaft 48 and the inner race 52. In alternative embodiments of the invention, the clutch 50 could be configured differently than a sprag clutch. Also, in embodiments of the invention in which the clutch 50 is a sprag clutch, the inner race 52 could be defined by the tower shaft 40 and/or the outer race could be a structure distinct from the starter shaft 48.

Generally, a sprag clutch is a free-wheel device having an inner race, an outer race, and plurality of sprags disposed between the inner and outer races. The sprag clutch is a one-directional positive clutch design that connects two shafts when rotating motion causes the sprags between the inner and outer races to wedge together. Either of the inner race or the outer race can be the input or output member. The input member can be arranged to drive the output member in a chosen direction and permit the output member to over-run in the same direction. The sprags can be shaped like a figure eight and cocked with a spring. Sprag clutches are able to transmit greater torques, within given overall dimensions, than other types of free-wheel device.

In operation, the tower shaft 40 can be rotated about the axis 42 by a power source (not shown). The tower shaft 40 can cause the starter shaft 48 to rotate through the clutch 50. The gear 46 can therefore also rotate in response to rotation of the tower shaft 40. The gear 46 can drive the gear 44 to rotate about the centerline axis 30, resulting also in rotation of the high pressure shaft 28 about the centerline axis 30. The tower shaft 40 can thus impart initial rotation to the high pressure shaft 28 to start the operation of the turbine engine 10. The clutch 50, the starter shaft 48, and the gears 44, 46 thus define a first coupling arrangement between the tower shaft 40 and the high pressure shaft 28.

The tower shaft 40 can also be operably engaged with the low pressure shaft 26 to communicate power to accessories of the turbine engine 10. In the exemplary embodiment of the invention, a gear 56 can be fixed to the low pressure shaft 26. A gear 58 can be positioned to mesh with the gear 56. The gear 58 can be fixed to the tower shaft 40. In the exemplary embodiment, the gear 58 can be integral with the tower shaft 40, but this is not required of the broader invention. In operation, the low pressure shaft 26 can be initially rotated by the tower shaft 40 through the second coupling arrangement defined by the gears 56 and 58. Once the turbine engine is operating, power can be transmitted from the low pressure shaft 26 to accessories through the tower shaft 40, as will be discussed more fully below.

After the low and high pressure shafts 26, 28 have been initially rotated by the tower shaft 40, the turbine engine 10 will be running and producing power. In some turbine engines, the low pressure shaft 26 and the high pressure shaft 28 can rotate at different speeds during operation. For example, the low pressure shaft 26 can have a maximum angular velocity of about 25,000 revolutions per minute (rpm) and the high pressure shaft 28 can have a maximum angular velocity of about 50,000 rpm. These numbers are provided for illustrative purposes and are not limiting on the broader invention.

The placement of the clutch 50 between the tower shaft 40 and the high pressure shaft 28 results in the tower shaft 40 and the high pressure shaft 28 being engaged with one another for concurrent rotation up to a first angular velocity. During this phase of operation, the tower shaft 40 is driving rotation of the high pressure shaft 28. As soon as the high pressure shaft 28 rotates faster than the tower shaft 40, the exemplary sprag clutch 50 will mechanically disengage and the starter shaft 48 will overrun the tower shaft 40, allowing power to be drawn from the low pressure shaft 26. Thus, the tower shaft 40 can be engaged with the high pressure shaft 28 for temporary or intermittent concurrent rotation; the tower shaft 40 and the high pressure shaft 28 rotate concurrently during desired periods and not continuously. The clutch 50 permits relative rotation between the tower shaft 40 and the high pressure shaft 28 when the high pressure shaft 28 is rotating faster than the first angular velocity.

The first angular velocity can be the maximum angular velocity of the low pressure shaft 26. While the high pressure shaft 28 and tower shaft 40 can be engaged for discontinuous concurrent rotation, the low pressure shaft 26 and the tower shaft 40 can be engaged for continuous concurrent rotation in the exemplary embodiment of the invention. During start-up of the turbine engine 10, the coupling defined by the gears 56, 58 results in the tower shaft 40 driving the low pressure shaft 26 as well as the high pressure shaft 28. When the turbine engine 10 is operating, the coupling defined by the gears 56, 58 results in the low pressure shaft 26 driving the tower shaft 40 in rotation. It is noted that the power provided to the tower shaft 40 during start-up of the turbine engine 10 ceases when the turbine engine 10 begins operating; thus, the tower shaft 40 would not be subjected to power input simultaneously at opposite ends.

The exemplary gears 44, 46, 56 and 58 are shown as bevel gears. However, other coupling structures could be applied in other embodiments of the invention, such as spur gears or splines. For example, if the axis 42 of the tower shaft 40 extended parallel to the centerline axis 30 of the high and low pressure shafts 26, 28, the gears 44, 46, 56 and 58 could be spur gears. Also, the gears 46 and 58 are nested to minimize space. However, the gears 46 and 58 can be positioned differently in alternative embodiments of the invention. The gears 56 and 44, respectively associated with the low pressure shaft 26 and high pressure shaft 28, are spaced from one another along the axis 30, but could be aligned along the axis 30 in alternative embodiments of the invention.

The location of the tower shaft 40 within the turbine engine 10 is not limited by the present invention. The tower shaft 40 can engage either the low pressure shaft 26 and/or the high pressure shaft 28 at any location along the centerline axis 30 in alternative embodiments of the invention. Also, the orientation of the tower shaft 40 relative to either of the low pressure shaft 26 or the high pressure shaft 28 is not limited by the depictions in the Figures. The tower shaft 40 can be transverse to at least one of the high pressure shaft 28 and the low pressure shaft 26, perpendicular or less than perpendicular. The exemplary tower shaft 40 is shown to be substantially perpendicular to both of the high pressure shaft 28 and the low pressure shaft 26, extending along an axis 42.

It is further noted that embodiments of the invention, including the embodiment described above, can be designed based on the lowest operating speed of the low pressure shaft 26. For example, the accessories need not be oversized to compensate for the relatively lower speed of rotation of the low pressure shaft 26 compared to the high pressure shaft 28. The gearing between the accessories and the tower shaft 40 can be designed so that the accessories will receive sufficient power even when the low pressure shaft 26 is rotating at a minimum speed.

It is noted that the invention, including but not limited to the exemplary embodiment described above, can be applied to operating environments in which the two shafts 26, 28 are co-rotating and operating environments in which the two shafts 26, 28 are counter-rotating. For example, the gear 56 could be placed on the back-side of gear 58, rather than on the front-side as is shown in the drawings.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A turbine engine comprising:
a compressor section having a low pressure portion and a high pressure portion;
a turbine section spaced from said compressor section along a centerline axis and having a low pressure portion and a high pressure portion;
a low pressure shaft extending between said low pressure portion of said compressor section and said low pressure portion of said turbine section;
a high pressure shaft extending between said high pressure portion of said compressor section and said high pressure portion of said turbine section; and
a tower shaft operably engageable with both of said low pressure shaft and said high pressure shaft and selectively coupled with said high pressure shaft through a clutch encircling said tower shaft.

2. The turbine engine of claim 1 wherein said tower shaft extends transverse to at least one of said high pressure shaft and said low pressure shaft.

3. The turbine engine of claim 2 wherein said tower shaft is substantially perpendicular to both of said high pressure shaft and said low pressure shaft.

4. The turbine engine of claim 1 wherein said tower shaft is further defined as being engaged with both of said low pressure shaft and said high pressure shaft for at least intermittent concunent rotation.

5. The turbine engine of claim 4 wherein said tower shaft is engaged with said high pressure shaft for intermittent concunent rotation and is engaged with said low pressure shaft for continuous concunent rotation.

6. (canceled)

7. The turbine engine of claim 1 wherein said clutch is operably positioned between said tower shaft and said high pressure shaft to engage said tower shaft and said high pressure shaft together for concurrent rotation up to a first angular velocity and to permit relative rotation between said tower shaft and said high pressure shaft when said high pressure shaft is rotating faster than the first angular velocity.

8. The turbine engine of claim 7 wherein the first angular velocity is the maximum angular velocity of said low pressure shaft.

9. The turbine engine of claim 6 wherein said clutch is further defined as a sprag clutch.

10. The turbine engine of claim 1 further comprising:
a starter shaft encircling said tower shaft; and
wherein said clutch is a sprag clutch positioned between said starter shaft and said tower shaft, said starter shaft defining an outer race of said sprag clutch.

11. The turbine engine of claim 10 further comprising:
a first gear rotationally fixed with respect to said starter shaft for engaging said high pressure shaft; and
a second gear rotationally fixed with respect to said tower shaft for engaging said low pressure shaft, said first and second gears being spaced from one another along a longitudinal axis of said tower shaft.

12. The turbine engine of claim 11 wherein said first and second gears are bevel gears.

13. The turbine engine of claim 12 wherein said first and second bevel gears are nested with respect to one another.

14. A method of transmitting power among a plurality of shafts in a turbine engine comprising the steps of:
imparting initial rotation to a high pressure shaft with a tower shaft through a first coupling anangement including a clutch encircling the tower shaft; and
transmitting power though the tower shaft from a low pressure shaft though a second coupling anangement after said step of imparting initial rotation to the high pressure shaft.

15. The method of claim 14 wherein said imparting step is further defined as:
imparting initial rotation to both the high pressure shaft and the low pressure shaft with the tower shaft.

16. The method of claim 14 further comprising the step of:
overrunning the high pressure shaft relative to the tower shaft.

17. The method of claim 14 further comprising the step of:
fixing the low pressure shaft and the tower shaft together for continuous concurrent rotation.

18. The method of claim 14 wherein said transmitting step is further defined as:
transmitting power though the tower shaft only from the low pressure shaft.

19. The method of claim 14 wherein:
said imparting step is further defined as imparting initial rotation to the high pressure shaft with the tower shaft only during engine start-up; and
said transmitting step is further defined as transmitting power through the tower shaft from the low pressure shaft during operation of the turbine engine after engine start-up.

20. An apparatus for practicing the method of claim 14 comprising the turbine engine of claim 1.
